(19) United States
(12) Patent Application Publication
(10) Pub. No.: US 2026/0094528 A1
(43) Pub. Date: Apr. 2, 2026

(54) SYSTEMS AND METHODS FOR INSPECTING A VEHICLE

(71) Applicant: Ford Global Technologies, LLC, Dearborn, MI (US)

(72) Inventors: Jeff Tornabene, Canton, MI (US); Sam Hoff, Hazel Park, MI (US); Suneet Singh, Northville, MI (US)

(73) Assignee: Ford Global Technologies, LLC, Dearborn, MI (US)

(21) Appl. No.: 18/901,907

(22) Filed: Sep. 30, 2024

(51) Int. Cl. G09B 5/06; G06T 7/00; G06T 19/00

(52) U.S. Cl. CPC G09B 5/065; G06T 7/0004; G06T 19/006; G06T 2207/30248

(57) ABSTRACT

A method includes the receipt of a video stream from a mixed-media device that captures one or more components of a vehicle, the detection of one or more defects associated with the one or more components of the vehicle, the transmission of dynamic feedback to an operator of the mixed-media device from a processor, and the guidance of the operator to address the one or more defects via the mixed-media device.

### FIELD

The present disclosure relates to inspecting one or more components of a vehicle, and more particularly, to systems and methods for vehicle inspection using a mixed-media device.

### BACKGROUND

The statements in this section merely provide background information related to the present disclosure and may not constitute prior art.

Warranty and internal repair issues associated with a production of a vehicle typically relate to improperly installed components rather than the components being defective. Because the verification of whether a component was properly installed may be considered an additional manufacture-related task, the production process may require rebalancing to accommodate such a verification. However, without verifying whether the component was properly installed in real-time, inefficiencies can arise in the production process such as waste, re-work, unsatisfactory communication, or a combination thereof.

The present disclosure addresses these and other issues related to the inspection of the vehicle.

### SUMMARY

This section provides a general summary of the disclosure and is not a comprehensive disclosure of its full scope or all of its features.

The present disclosure provides a method comprising: receiving, by a processor, a video stream from a mixed-media device that captures one or more components of a vehicle; detecting, by an algorithm associated with the processor, one or more defects associated with the one or more components of the vehicle in response to receiving the video stream; transmitting, via the mixed-media device, dynamic feedback to an operator of the mixed-media device from the processor based on the detection of the one or more defects; and guiding the operator, via the mixed-media device, to address the one or more defects based on the transmission of the dynamic feedback; wherein the video stream comprises one or more images within a field of view of the mixed-media device; wherein the dynamic feedback includes one or more instructions, the method further comprising: transmitting the one or more instructions to the operator via the mixed-media device, wherein the one or more instructions facilitate directing the field of view of the mixed-media device to successfully complete an inspection of the one or more components; wherein the dynamic feedback is displayed on a user interface of the mixed-media device, is audibly received by the operator via one or more transducers of the mixed-media device, or a combination thereof; wherein transmitting the dynamic feedback to the operator further comprises: causing a dynamic update to the user interface to be displayed to the operator, wherein the dynamic update indicates a proper installation of the one or more components via one or more bounding boxes associated with the one or more components, a color associated with the proper installation of the one or more components, a change of color indicating that the operator has addressed the one or more defects, or a combination thereof; wherein the dynamic feedback includes one or more augmented-reality images, the method further comprising: generating the one or more augmented-reality images based on the captured one or more components, wherein the one or more augmented-reality images include one or more instructions that indicate proper installation of the one or more components; and superimposing the one or more augmented-reality images onto the user interface of the mixed-media device; wherein the dynamic feedback includes a first set of one or more video instructions or a second set of one or more video instructions, the method further comprising: transmitting, via the mixed-media device, the first set of one or more video instructions to the operator based on the captured one or more components, wherein the first set of one or more video instructions include one or more steps for properly installing the one or more components; or transmitting, via the mixed-media device, the second set of one or more video instructions to the operator based on the detection of the one or more defects, wherein the second set of one or more video instructions include one or more steps for removing the one or more components from the vehicle and the one or more steps for properly installing the one or more components; and wherein the dynamic feedback includes one or more voice notes, the method further comprising: receiving, by the processor, the one or more voice notes based on a voice command of the operator, wherein the one or more voice notes is associated with the video stream from the mixed-media device, and wherein the voice command is indicative of an operator-detected one or more defects.

The present disclosure provides a system comprising: a processor configured to: receive a video stream from a mixed-media device that captures one or more components of a vehicle, detect, by an algorithm associated with the processor, one or more defects associated with the one or more components of the vehicle in response to receiving the video stream, transmit, via the mixed-media device, dynamic feedback to an operator of the mixed-media device from the processor based on the detection of the one or more defects, and guide the operator, via the mixed-media device, to address the one or more defects based on the transmission of the dynamic feedback; and the mixed-media device configured to: transmit the video stream, receive the dynamic feedback, and communicate the dynamic feedback to the operator, wherein the dynamic feedback is displayed on a user interface of the mixed-media device, is audibly received by the operator via one or more transducers of the mixed-media device, or a combination thereof; wherein the video stream comprises one or more images within a field of view of the mixed-media device; wherein the dynamic feedback includes one or more instructions, the processor further configured to: transmit the one or more instructions to the operator via the mixed-media device, wherein the one or more instructions facilitate directing the field of view of the mixed-media device to successfully complete an inspection of the one or more components; wherein the processor configured to transmit the dynamic feedback to the operator is further configured to: cause a dynamic update to the user interface to be displayed to the operator, wherein the dynamic update indicates a proper installation of the one or more components via or more bounding boxes associated with the one or more components, a color associated with the proper installation of the one or more components, a change of color indicating that the operator has addressed the one or more defects, or a combination thereof; wherein the dynamic feedback includes one or more augmented-reality images, the processor further configured to: generate the one or more augmented-reality images based on the captured one or more components, wherein the one or more augmented-reality images include one or more instructions that indicate proper installation of the one or more components; and superimpose the one or more augmented-reality images onto the user interface of the mixed-media device; wherein the dynamic feedback includes a first set of one or more video instructions or a second set of one or more video instructions, the processor further configured to: transmit, via the mixed-media device, the first set of one or more video instructions to the operator based on the captured one or more components, wherein the first set of one or more video instructions include one or more steps for properly installing the one or more components; or transmit, via the mixed-media device, the second set of one or more video instructions to the operator based on the detection of the one or more defects, wherein the second set of one or more video instructions include one or more steps for removing the one or more components from the vehicle and the one or more steps for properly installing the one or more components; and wherein the dynamic feedback includes one or more voice notes, the processor further configured to: receive, by the processor, the one or more voice notes based on a voice command of the operator, wherein the one or more voice notes is associated with the video stream from the mixed-media device.

The present disclosure provides one or more non-transitory computer-readable media storing processor-executable instructions that, when executed by at least one processor, cause the at least one processor to: receive, by a processor, a video stream from a mixed-media device that captures one or more components of a vehicle; detect, by an algorithm associated with the processor, one or more defects associated with the one or more components of the vehicle in response to receiving the video stream; transmit, via the mixed-media device, dynamic feedback to an operator of the mixed-media device from the processor based on the detection of the one or more defects; and guide the operator, via the mixed-media device, to address the one or more defects based on the transmission of the dynamic feedback; wherein the video stream comprises one or more images within a field of view of the mixed-media device; wherein dynamic feedback includes one or more instructions, and wherein the at least one processor is further caused to: transmit the one or more instructions to the operator via the mixed-media device, wherein the one or more instructions facilitate directing the field of view of the mixed-media device to successfully complete an inspection of the one or more components; wherein the dynamic feedback is displayed on a user interface of the mixed-media device, is audibly received by the operator via one or more transducers of the mixed-media device, or a combination thereof; and wherein the at least one processor caused to transmit the dynamic feedback to the operator is further caused to: cause a dynamic update to the user interface to be displayed to the operator, wherein the dynamic update indicates a proper installation of the one or more components via one or more bounding boxes associated with the one or more components, a color associated with the proper installation of the one or more components, a change of color indicating that the operator has addressed the one or more defects, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram of a vision system associated with an inspection of one or more components of a vehicle in accordance with one or more embodiments of the present disclosure;

FIG. 2 is an example environment related to the vision system in accordance with one or more embodiments of the present disclosure;

FIG. 3 is a flowchart illustrating an example method for performing the inspection of the one or more components associated with a vehicle in accordance with one or more embodiments of the present disclosure;

FIG. 4 a flowchart illustrating another example method for performing the inspection of the one or more components associated with a vehicle in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for vehicle inspection that can reduce tasks completed by an operator, in real-time, and allow for a more optimal process (e.g., correct angle, adequate lighting, sufficient proximity to a vehicle, etc.) to be performed. For example, real-time inspection of the vehicle in a production process can be performed. Integration of real-time video collection to the operator (e.g., close to install), which can include the provision of an enhanced vantage point for image collection, can also be provided. Streaming of the video and/or images in real-time via Wi-Fi, 5G Bluetooth®, or other means to a computer device for inferencing of the video and/or images additionally can be provided.

In one or more example, the origination of the video and/or images can be from one or more than one camera on a mixed-media device. Additionally, the screen of the mixed-media device can provide feedback to the operator related to inspections that should be completed, as well as indicate when an inspection has been completed, in addition to the outcome of the inspection (e.g., success or otherwise). In one or more examples, the operator can be provided with guidance that directs the operator as to where to look to perform the next task and/or inspection (e.g., audibly and/or visually). Also, immediate feedback, to the operator, of the unsuccessful inspection can be provided, which allows the operator to correct the error, use one or more voice commands to flag the issue(s) for downstream repair in the production process, and/or use one or more voice commands to provide feedback to the system that the inspection was unsuccessful.

One or more examples provide the ability to override an inspection that can cause the system to save the source video and route the video to an artificially intelligent training platform for additional model training. One or more photos of potential concern(s) can also be sent to another party and paired with comments in the form of feedback. One or more still photos of unsuccessful inspections can be captured and routed in one or more examples to downstream workstation(s) for repair, along with an option for the operator to add one or more voice notes for the repair technician to take various actions (e.g., call a particular person for details associated with the inspection).

One or more examples additionally can provide an ability to use voice tools to collect operator feedback; a continuous enhancement of ideas; a provision of one or more alerts to an operator; a capture of video(s) for operator training; an ability to collect training video(s) during the production process; an ability to broadcast to the operator so they are made aware of an incoming vehicle; a provision of a model mix; a provision of an operator task list and/or an indication of when an action of a production process has been made (e.g., completed, bypassed, etc.); a provision of guidance during an event (e.g., natural disaster, active shooter, etc.); or integration with one or more learning models.

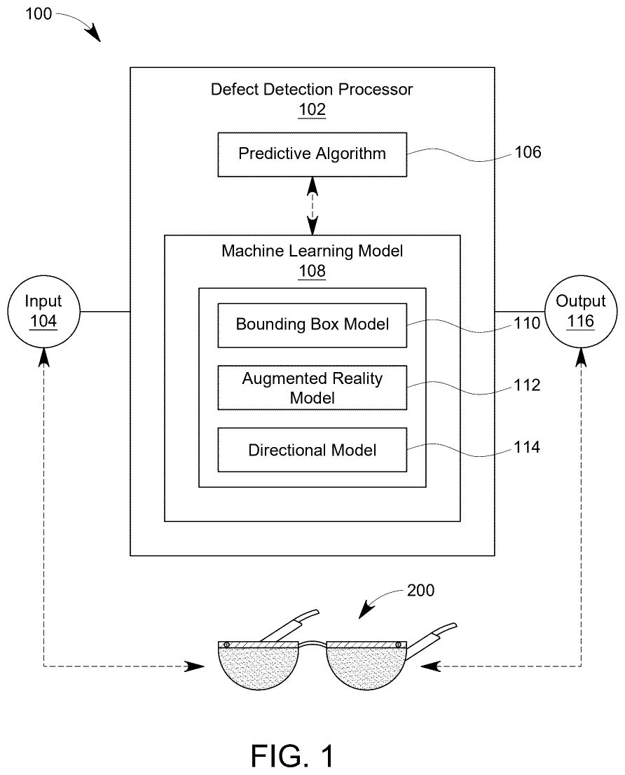

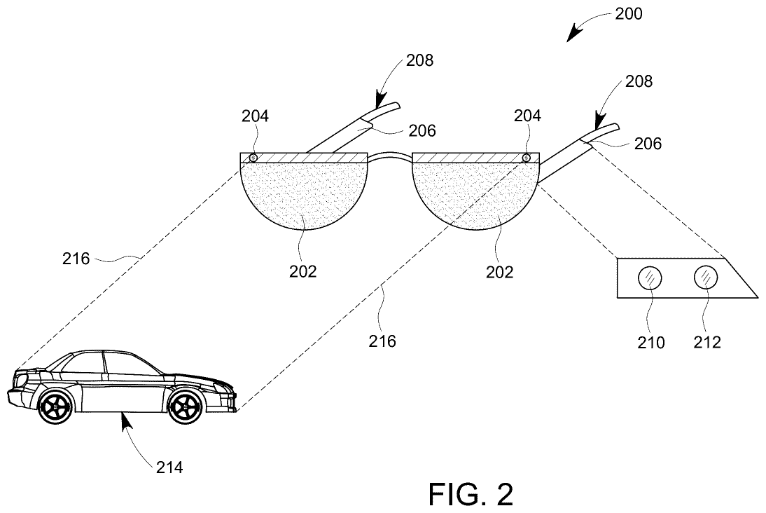

FIG. 1 illustrates an example vision system 100 associated with an inspection of one or more components associated with a vehicle (e.g., a vehicle 214 as shown in FIG. 2). However, it is understood that the vision system 100 can be applied to an inspection process associated with any structure and is not limited to the inspection of the vehicle 214 and/or the one or more components associated with the vehicle 214.

In one or more embodiments, the inspection of the one or more components of the vehicle 214 is supported by a mixed-media device (e.g., a mixed-media device 200 as shown in FIG. 2) in communication with a defect detection processor 102. The defect detection processor 102 is configured to detect one or more defects associated with the one or more components of the vehicle 214 in response to receiving a video stream (e.g., a real-time or live video stream) that originates from the mixed-media device 200. As an example, the mixed-media device 200 can be any electronic device wearable by an operator (e.g., a human operator) such as, but not limited to, eyeglasses, a head-mounted camera, or a body camera. It is understood that the defect detection processor 102 can be partially or entirely externally disposed within a computer (e.g., an edge PC) separate from the mixed-media device 200 or partially or entirely internally disposed within the mixed-media device 200.

Referring to FIG. 2, the mixed-media device 200 can include one or more lenses 202, one or more sensors 204, one or more casings 206, and one or more arms 208. It is understood that while the mixed-media device 200 shown in FIG. 2 depicts a duality of the lenses 202, a duality of the sensors 204, a duality of the casings 206 (e.g., housings), and a duality of the arms 208, the mixed-media device 200 can include any number (e.g., more or less than two) of the lenses 202, the sensors 204, the casings 206, and/or the arms 208. In one or more embodiments, the one or more lenses 202 is configured to display content to the operator of the mixed-media device 200. However, it is understood that the operator of the mixed-media device 200 is also able to view any setting within a field of view 216 of the operator beyond the one or more lenses 202 by viewing the setting through the one or more lenses 202. In other words, the display of the content to the operator of the mixed-media device 200 does not obstruct a viewing capability of the setting beyond the one or more lenses 202 that would otherwise be within the field of view 216 of the operator of the mixed-media device 200 (e.g., viewed through the lenses 202).

The one or more sensors 204 is disposed on the mixed-media device 200 proximate the one or more lenses 202 and is configured to capture the field of view 216 of the operator. However, it is understood that the one or more sensors 204 can be disposed upon, or integrated within, any portion of the construct associated with the mixed-media device 200. The one or more sensors 204 can have one or more camera, lidar, radar, and/or ultrasonic capabilities.

Additionally, the one or more casings 206 can include one or more transducers 210 and/or one or more receivers 212. As an example, the one or more transducers 210 can be an array of speakers configured to output audio sound waves to the operator of the mixed-media device 200. As another example, the one or more receivers 212 can be an array of microphones configured to receive one or more voice commands (e.g., one or more voice notes) from the operator. For example, the one or more voice commands can include feedback observed by the operator related to the one or more components that provides contextual feedback to the defect detection processor 102. As another example, the contextual feedback can enhance the processing of an input 104 by the predictive algorithm 106 as is described herein. The one or more casings 206 is affixed to the one or more arms 208 of the mixed-media device 200. However, it is understood that the one or more casings 206 can be affixed to any portion of the construct associated with the mixed-media device 200.

Referring back to FIG. 1, the video stream and/or one or more voice commands, is obtained as the input 104 by the defect detection processor 102. For example, the input 104 is wirelessly transmitted from the mixed-media device 200 to the defect detection processor 102. As another example, the transmission of the input 104 is wirelessly supported by a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, a Light Fidelity (Li-Fi) type protocol, among others). As an example, the defect detection processor 102 is also configured to receive the one or more voice commands as the input 104. The defect detection processor 102 includes a predictive algorithm 106 that is configured to process the obtained video stream and/or voice commands (e.g., the input 104).

As an example, and based on the processing of the input 104, the predictive algorithm 106 is configured to stich each image of a plurality of individual images in a case wherein the input 104 is received as a plurality of individual images. As a further example, the dynamically received input 104 enables training (e.g., supervised or unsupervised) of the predictive algorithm 106. As an additional example, the training of the predictive algorithm 106 can be enhanced based on the contextual feedback received as the one or more voice commands. As another example, and based on the processing of the input 104, the predictive algorithm 106 is configured to analyze the input 104 to detect whether there are any defects associated with any of the one or more components. As another example, and based on the processing of the input 104 and/or the detection of whether there are any defects associated with any of the one or more components, the predictive algorithm 106 can provide optimized feedback to the operator of the mixed-media device 200 by exchanging one or more data elements (e.g., associated with the input 104) with one or more machine learning models 108. The one or more machine learning models 108 can include a bounding box model 110, an augmented reality model 112, and a directional model 114. However, it is understood that the one or more machine learning models 108 can include any number of models related to the inspection of the vehicle 214.

In one or more embodiments, the predictive algorithm 106 is configured to process the input 104 to determine whether the one or more components is improperly installed in relation to the vehicle 214. In response to the predictive algorithm 106 determining that there are one or more components improperly installed in relation to the vehicle 214, the bounding box model 110 is configured to generate a bounding box (e.g. a virtual bounding box) around the improperly installed one or more components and displayed by the mixed-media device 200 as described in more detail herein. It is understood, however, that the bounding box model 110 can generate a bounding box around each of the one or more components regardless of whether the one or more components is improperly installed. In a case wherein the bounding box model 110 generates a bounding box around each of the one or more components, the bounding box model 110 can highlight the improperly installed one or more components by causing the bounding box around the improperly installed one or more components to appear (e.g., displayed to the operator) as a highlighted or emphasized box, such as a thicker, brighter, and/or a different color than the bounding boxes that are generated around each of the one or more properly installed one or more components. It is understood that the bounding box model 110 can highlight the improperly installed one or more components in any way wherein the operator is able distinguish the improperly installed one or more components from the properly installed one or more components.

In one or more embodiments, and in a case wherein any of the one or more components has one or more potential mating orientations, the augmented reality model 112 is configured to generate feedback associated with a proper installation (e.g., proper orientation) of the one or more components that have the one or more potential mating orientations. Similarly, in a case wherein any of the one or more components can be placed in one or more modes, the augmented reality model 112 is configured to generate feedback associated with a proper installation of the one or more components that have the one or more potential viable modes. It is understood that in either case, the augmented reality model 112 can generate the feedback associated with the proper installation of the one or more components in response to the processing of the input 104 by the predictive algorithm 106 (e.g., based on the field of view 216 of the operator or one or more voice commands from the operator).

In one or more embodiments, the predictive algorithm 106 is configured to process the input 104 to determine whether the one or more components is improperly installed in relation to the vehicle 214. In response to the predictive algorithm 106 determining that there are one or more components improperly installed in relation to the vehicle 214, the directional model 114 is configured to display one or more instructions to the operator of the mixed-media device 200. As an example, the one or more instructions can include a procedure for removing the improperly installed one or more components, as well as a procedure for correctly installing the one or more components. It is understood, however, that the directional model 114 is configured to display the one or more instructions to the operator regardless of whether the determination is made as to whether the one or more components is improperly installed in relation to the vehicle 214. For example, the directional model 114 can be configured to display the one or more instructions to the operator in response to the processing of the input 104 by the predictive algorithm 106 (e.g., based on the field of view 216 of the operator or one or more voice commands from the operator). Is also understood that the one or more instructions can be step-by-step instructions such as video instructions and/or a displayed list of instructions. It is further understood that the one or more instructions can be any form of procedural-related instructions associated with the installation of the one or more components.

As another example, the one or more instructions can include one or more directional indications (e.g., directional arrows) that instruct the operator to change the field of view 216 associated with the setting viewed through the one or more lenses 202. For example, the one or more directional indications can instruct the operator to look at a different component from an originally viewed component of the one or more components. As yet another example, the one or more directional indications can be generated in a case wherein the inspection of the one or more components require multiple angles, images, or components that cannot be viewed within a single field of view 216. In other words, the one or more directional indications can be generated in a case wherein the inspection of the one or more components requires the operator to move (e.g., change position) about the vehicle 214 to capture each required viewpoint of each of the inspected one or more components. It is understood that the one or more directional indications can be provided to the operator based on a global reference of any of the one or more components or a local reference associated with a current position of the mixed-media device 200 in relation to any of the one or more components. The one or more directional indications can be any indicator of direction and can be of any type and take different forms and configurations.

As a further example, the one or more instructions can also include one or more video-based guides displaying a location of any of the one or more components, as well as an example of correct installation of the displayed one or more components. As yet another example, the one or more instructions can further include one or more audio-based guides provided to the operator of the mixed-media device 200 via the one or more transducers 210. As a further example, the one or more instructions can lock onto any of the one or more components and guide the operator to adjust the field of view 216 based on tracking of the locked onto one or more components.

In one or more embodiments, the defect detection processor 102 is configured to provide feedback to the operator of the mixed-media device 200 as an output 116. As an example, the feedback can be visually displayed on the one or more lenses 202 of the mixed-media device 200 and/or audibly provided to the operator via the one or more transducers 210 of the mixed-media device 200. For example, the bounding box generated around the improperly installed one or more components is displayed to the operator via the mixed-media device 200. As another example, the feedback generated by the augmented reality model 112 is displayed to the operator via the mixed-media device 200. As yet another example, the one or more instructions is displayed and/or audibly provided to the operator via the mixed-media device 200. In each case, it is understood that the output 116 is instructive of how the operator of the mixed-media device 200 should address (e.g., resolve, mitigate, etc.) an instance of one or more defects associated with the one or more components of the vehicle 214. In one or more embodiments, the operator of the mixed-media device 200 can receive a prioritized listing of an order of which of the one or more defects should be addressed based on one or more considerations, such as a severity of the one or more defects, a speed at which the one or more defects should be resolved, or a proximity of the one or more defects from the operator. For example, the prioritized listing can be generated by the predictive algorithm 106.

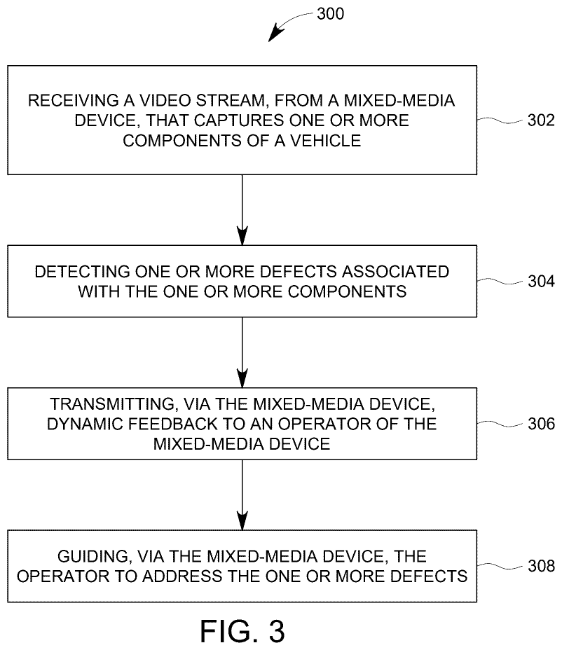

FIG. 3 is a flowchart illustrating an example method 300 for inspecting one or more components associated with a vehicle (e.g., the vehicle 214) within a vision system (e.g., the vision system 100). At operation 302, a video stream is received (e.g., the input 104) from a mixed-media device (e.g., the mixed media device 200). For example, the video stream is received at a processor (e.g., the defect detection processor 102). As another example, the video stream captures one or more components of the vehicle. As yet another example, the video stream comprises one or more images within a field of view (e.g., the field of view 216) of the mixed-media device.

At operation 304, one or more defects associated with the one or more components of the vehicle is detected. For example, the one or more defects is detected by an algorithm (e.g., the predictive algorithm 106) associated with the processor. As another example, the one or more defects is detected in response to receiving the video stream.

At operation 306, dynamic feedback is transmitted (e.g., the output 116) to the operator of the mixed-media device from the processor. For example, the dynamic feedback is transmitted to the operator of the mixed-media device via the mixed-media device. As another example, the dynamic feedback is transmitted based on the detection of the one or more defects. As yet another example, the dynamic feedback is displayed on a user interface of the mixed-media device, is audibly received by the operator via one or more transducers (e.g., the one or more transducers 210) of the mixed-media device, or a combination thereof. The user interface can be a dynamic display and/or method of communication, whereby the operator can communicate with the defect detection processor 102 via the mixed media device 200, for example.

As a further example, the user interface is provided to the operator via one or more lenses (e.g., the one or more lenses 202) of the mixed-media device. As an additional example, the dynamic feedback includes one or more instructions. In one or more embodiments, the one or more instructions are transmitted to the operator. For example, the one or more instructions are transmitted to the operator via the mixed-media device. As another example, the one or more instructions facilitate directing the field of view of the mixed-media device to successfully complete an inspection of the one or more components.

As yet another example, the dynamic feedback includes one or more augmented-reality images. In another one or more embodiments, the one or more augmented-reality images is generated based on the captured one or more components. In the another one or more embodiments, the one or more augmented-reality images is superimposed onto the user interface of the mixed media device. For example, the one or more augmented-reality images includes one or more instructions that indicate proper installation of the one or more components.

As another example, the dynamic feedback includes a first set of one or more video instructions. In another one or more embodiments, the first set of one or more video instructions is transmitted to the operator. For example, the first set of one or more video instructions is transmitted to the operator via the mixed-media device. As another example, the transmission of the first set of one or more video instructions is based on the captured one or more components. As yet another example, the first set of one or more video instructions include one or more steps for properly installing the one or more components.

As a further example, the dynamic feedback includes a second set of one or more video instructions. In a further one or more embodiments, the second set of one or more video instructions is transmitted to the operator. For example, the second set of one or more video instructions is transmitted to the operator via the mixed-media device. As another example, the transmission of the second set of one or more video instructions is based on the detection of the one or more defects. As yet another example, the second set of one or more video instructions include one or more steps for removing the one or more components from the vehicle and/or the one or more steps for properly installing the one or more components.

As yet another example, the dynamic feedback includes one or more voice notes. In yet an additional one or more embodiments, the one or more voice notes is received by the processor. For example, the one or more voice notes is received based on a voice command of the operator. As another example, the one or more voice notes is associated with the video stream from the mixed-media device. As yet another example, the voice command is indicative of an operator-detected one or more defects.

In one or more embodiments, a dynamic update to the user interface is caused to be displayed to the operator. For example, the dynamic update indicates a proper installation of the one or more components via one or more bounding boxes associated with the one or more components, a color associated with the proper installation of the one or more components, a change of color indicating that the operator has addressed the one or more defects, or a combination thereof. At operation 308, the operator is guided to address the one or more defects based on the transmission of the dynamic feedback.

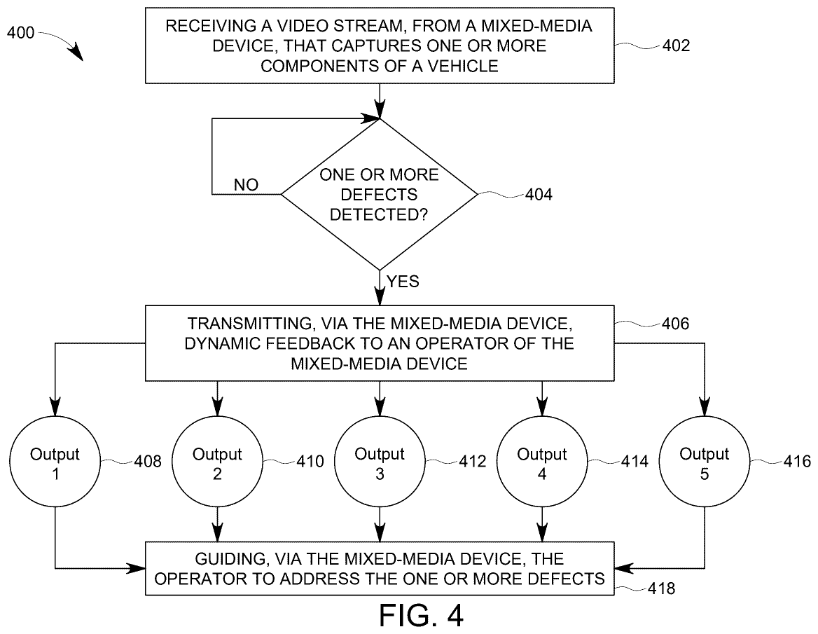

FIG. 4 is a flowchart illustrating another example method 400 for inspecting one or more components associated with a vehicle (e.g., the vehicle 214) within a vision system (e.g., the vision system 100). At operation 402, a video stream is received (e.g., the input 104) from a mixed-media device (e.g., the mixed media device 200). For example, the video stream is received at a processor (e.g., the defect detection processor 102). As another example, the video stream captures one or more components of the vehicle.

At operation 404, an analysis is made by the processor to determine whether one or more defects associated with the one or more components of the vehicle exist. In a case wherein no defects associated with the one or more components of the vehicle exist, the analysis is performed again (e.g., at a different time, after receiving another input 104, etc.). However, in a case wherein one or more defects associated with the one or more components of the vehicle are detected, dynamic feedback is transmitted (e.g., the output 116) to the operator of the mixed-media device from the processor at operation 406. For example, the dynamic feedback is transmitted to the operator of the mixed-media device via the mixed-media device.

For example, the dynamic feedback transmitted at operation 408 (“Output 1”) includes one or more instructions that facilitate directing the field of view of the mixed-media device to successfully complete an inspection of the one or more components. As another, the dynamic feedback transmitted at operation 410 (“Output 2”) includes one or more augmented-reality images that is generated based on the captured one or more components and then superimposed onto a user interface of the mixed media device. For example, the one or more augmented-reality images includes one or more instructions that indicate proper installation of the one or more components.

As yet another example, the dynamic feedback transmitted at operation 412 (“Output 3”) includes a first set of one or more video instructions that includes one or more video-based steps for properly installing the one or more components. As a further example, the dynamic feedback transmitted at operation 414 (“Output 4”) includes a second set of one or more video instructions that includes one or more video-based steps for removing the one or more components from the vehicle and/or the one or more steps for properly installing the one or more components. As an additional example, the dynamic feedback transmitted at operation 416 (“Operation 5”) includes one or more voice notes received based on a voice command of the operator indicative of an operator-detected one or more defects. At operation 418, the operator is guided to address the one or more defects based on the transmission of the dynamic feedback at operations 408-416.

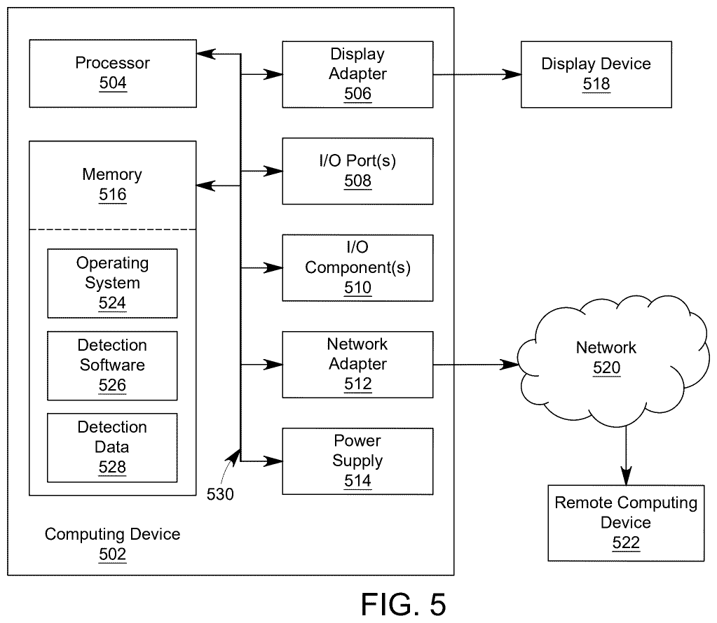

FIG. 5 illustrates an operating environment that facilitates the performance of one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. In some examples, the display device 502 forms part of the mixed-media device 200 and is configured to display a user-interface. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522 (e.g., the defect detection processor 102). For example, the remote computing device 522 can be a user device such as a cellular-phone, a smartphone, a tablet, a laptop, or a combination thereof, or other computing device. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, detection software 526, and detection data 528. For example, the operating system 524 is configured to manage and/or process any of the data and/or instructions associated with the detection software 526 and/or detection data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provides a means for inspecting a vehicle based on a real-time video stream of one or more components of the vehicle captured by a mixed-media device worn by an operator. One or more learning models is configured to detect whether one or more components of the vehicle are associated with a defect based on the real-time video stream. Detection of one or more defects are communicated to the operator via the mixed-media device, thereby guiding the operator on how to address the one or more defects.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
receiving, by a processor, a video stream from a mixed-media device that captures one or more components of a vehicle;
detecting, by an algorithm associated with the processor, one or more defects associated with the one or more components of the vehicle in response to receiving the video stream;
transmitting, via the mixed-media device, dynamic feedback to an operator of the mixed-media device from the processor based on the detection of the one or more defects; and
guiding the operator, via the mixed-media device, to address the one or more defects based on the transmission of the dynamic feedback.

2. The method of claim 1, wherein the video stream comprises one or more images within a field of view of the mixed-media device.

3. The method of claim 2, wherein the dynamic feedback includes one or more instructions, the method further comprising:
transmitting the one or more instructions to the operator via the mixed-media device, wherein the one or more instructions facilitate directing the field of view of the mixed-media device to successfully complete an inspection of the one or more components.

4. The method of claim 1, wherein the dynamic feedback is displayed on a user interface of the mixed-media device, is audibly received by the operator via one or more transducers of the mixed-media device, or a combination thereof.

5. The method of claim 4, wherein transmitting the dynamic feedback to the operator further comprises:
causing a dynamic update to the user interface to be displayed to the operator, wherein the dynamic update indicates a proper installation of the one or more components via one or more bounding boxes associated with the one or more components, a color associated with the proper installation of the one or more components, a change of color indicating that the operator has addressed the one or more defects, or a combination thereof.

6. The method of claim 4, wherein the dynamic feedback includes one or more augmented-reality images, the method further comprising:
generating the one or more augmented-reality images based on the captured one or more components, wherein the one or more augmented-reality images include one or more instructions that indicate proper installation of the one or more components; and
superimposing the one or more augmented-reality images onto the user interface of the mixed-media device.

7. The method of claim 1, wherein the dynamic feedback includes a first set of one or more video instructions or a second set of one or more video instructions, the method further comprising:
transmitting, via the mixed-media device, the first set of one or more video instructions to the operator based on the captured one or more components, wherein the first set of one or more video instructions include one or more steps for properly installing the one or more components; or
transmitting, via the mixed-media device, the second set of one or more video instructions to the operator based on the detection of the one or more defects, wherein the second set of one or more video instructions include one or more steps for removing the one or more components from the vehicle and the one or more steps for properly installing the one or more components.

8. The method of claim 1, wherein the dynamic feedback includes one or more voice notes, the method further comprising:
receiving, by the processor, the one or more voice notes based on a voice command of the operator, wherein the one or more voice notes is associated with the video stream from the mixed-media device, and wherein the voice command is indicative of an operator-detected one or more defects.

9. A system comprising:
a processor configured to:
receive a video stream from a mixed-media device that captures one or more components of a vehicle,
detect, by an algorithm associated with the processor, one or more defects associated with the one or more components of the vehicle in response to receiving the video stream,
transmit, via the mixed-media device, dynamic feedback to an operator of the mixed-media device from the processor based on the detection of the one or more defects, and
guide the operator, via the mixed-media device, to address the one or more defects based on the transmission of the dynamic feedback; and
the mixed-media device configured to:
transmit the video stream,
receive the dynamic feedback, and
communicate the dynamic feedback to the operator, wherein the dynamic feedback is displayed on a user interface of the mixed-media device, is audibly received by the operator via one or more transducers of the mixed-media device, or a combination thereof.

10. The system of claim 9, wherein the video stream comprises one or more images within a field of view of the mixed-media device.

11. The system of claim 10, wherein the dynamic feedback includes one or more instructions, the processor further configured to:
transmit the one or more instructions to the operator via the mixed-media device, wherein the one or more instructions facilitate directing the field of view of the mixed-media device to successfully complete an inspection of the one or more components.

12. The system of claim 9, wherein the processor configured to transmit the dynamic feedback to the operator is further configured to:
cause a dynamic update to the user interface to be displayed to the operator, wherein the dynamic update indicates a proper installation of the one or more components via or more bounding boxes associated with the one or more components, a color associated with the proper installation of the one or more components, a change of color indicating that the operator has addressed the one or more defects, or a combination thereof.

13. The system of claim 9, wherein the dynamic feedback includes one or more augmented-reality images, the processor further configured to:
generate the one or more augmented-reality images based on the captured one or more components, wherein the one or more augmented-reality images include one or more instructions that indicate proper installation of the one or more components; and
superimpose the one or more augmented-reality images onto the user interface of the mixed-media device.

14. The system of claim 9, wherein the dynamic feedback includes a first set of one or more video instructions or a second set of one or more video instructions, the processor further configured to:
transmit, via the mixed-media device, the first set of one or more video instructions to the operator based on the captured one or more components, wherein the first set of one or more video instructions include one or more steps for properly installing the one or more components; or
transmit, via the mixed-media device, the second set of one or more video instructions to the operator based on the detection of the one or more defects, wherein the second set of one or more video instructions include one or more steps for removing the one or more components from the vehicle and the one or more steps for properly installing the one or more components.

15. The system of claim 9, wherein the dynamic feedback includes one or more voice notes, the processor further configured to:
receive, by the processor, the one or more voice notes based on a voice command of the operator, wherein the one or more voice notes is associated with the video stream from the mixed-media device, and wherein the voice command is indicative of an operator-detected one or more defects.

16. One or more non-transitory computer-readable media storing processor-executable instructions that, when executed by at least one processor, cause the at least one processor to:
receive, by a processor, a video stream from a mixed-media device that captures one or more components of a vehicle;
detect, by an algorithm associated with the processor, one or more defects associated with the one or more components of the vehicle in response to receiving the video stream;
transmit, via the mixed-media device, dynamic feedback to an operator of the mixed-media device from the processor based on the detection of the one or more defects; and
guide the operator, via the mixed-media device, to address the one or more defects based on the transmission of the dynamic feedback.

17. The one or more non-transitory computer-readable media of claim 16, wherein the video stream comprises one or more images within a field of view of the mixed-media device.

18. The one or more non-transitory computer-readable media of claim 17, wherein dynamic feedback includes one or more instructions, and wherein the at least one processor is further caused to:
transmit the one or more instructions to the operator via the mixed-media device, wherein the one or more instructions facilitate directing the field of view of the mixed-media device to successfully complete an inspection of the one or more components.

19. The one or more non-transitory computer-readable media of claim 16, wherein the dynamic feedback is displayed on a user interface of the mixed-media device, is audibly received by the operator via one or more transducers of the mixed-media device, or a combination thereof.

20. The one or more non-transitory computer-readable media of claim 19, wherein the at least one processor caused to transmit the dynamic feedback to the operator is further caused to:
cause a dynamic update to the user interface to be displayed to the operator, wherein the dynamic update indicates a proper installation of the one or more components via one or more bounding boxes associated with the one or more components, a color associated with the proper installation of the one or more components, a change of color indicating that the operator has addressed the one or more defects, or a combination thereof.
